(19) United States
(12) Patent Application Publication
(10) Pub. No.: US 2026/0299730 A1
(43) Pub. Date: Oct. 1, 2026

(54) CAPACITIVE TOUCH DISPLAY APPARATUS AND TOUCH SENSING METHOD

(71) Applicant: FOCAL TECH SYSTEMS (SHENZHEN) CO., LTD., Shenzhen (CN)

(72) Inventors: JING-KAI ZHANG, Shenzhen,Guangdong (CN); BEI XIAO, Shenzhen,Guangdong (CN); JUN-QIAO LIU, Shenzhen,Guangdong (CN)

(21) Appl. No.: 19/489,341

(22) PCT Filed: Jun. 2, 2023
(86) PCT No.: PCT/CN2023/098153

§ 371 Date: Dec. 2, 2025

(51) Int. Cl. G06F 3/041; G06F 3/044

(52) U.S. Cl. CPC G06F 3/04184; G06F 3/04164; G06F 3/0446

(57) ABSTRACT

A capacitive touch display apparatus and a touch sensing method are provided. The capacitive touch display apparatus includes a touch panel, a display panel, a touch sensing control circuit, and a time controller. The touch panel comprises a touch electrode layer being patterned into first electrodes and second electrodes. In a touch sensing period, the first electrodes and the second electrodes are served as driving electrodes and sensing electrodes alternately. The touch sensing control circuit executes a synchronous process of driving signals and synchronous control signals outputted by the time controller, outputs the driving signals to the driving electrodes, and calculates capacitances of each of sensing capacitors formed by the sensing electrodes, for stopping refreshing a display image of the display panel in the touch sensing period. The driving signals are periodically in-phase signals.

### TECHNICAL FIELD

The present application generally relates to touch display technology, and particular to a capacitive touch display apparatus and a touch sensing method.

### BACKGROUND

A capacitive touch display apparatus includes a display. The touch display apparatus further includes a cover plate, a touch-control electrode layer, a first display layer, a dielectric layer, an illumination layer, and a second display electrode layer, which are overlapped in that order. The first display layer, a dielectric layer, a light-emitting layer, and a second display electrode layer form a display structure. Due to the first display electrode layer adjacent to the touch-control layer, while the touch-control layer loads a driving voltage for sensing a touch operation, capacitors formed between touch electrodes in the touch-control layer and first display electrodes in the first display electrode layer, the capacitance of each of the capacitors is larger. The capacitors will affect the first display electrodes, thus a display image of the display structure will be disturbed and in a result of screen flicker or Moire phenomena.

### SUMMARY

An aim of the present application is to provide a capacitive touch display apparatus and a touch control sensing method, in order to solve the technology problems in a prior art of a negative impact on the display structure being affected while the touch electrodes loading the driving voltage.

A capacitive touch display apparatus, includes a touch panel, a display panel, a touch sensing control circuit, and a time controller. The touch panel includes a cover plate and a touch electrode layer, which are overlapped in that order. The touch electrode layer is patterned into a plurality of first electrodes arranged along a first direction and a plurality of second electrodes arranged along a second direction. The touch sensing control circuit is electrically connected with the first electrodes and the second electrodes. In a touch sensing period, one of the first electrodes and the second electrodes serve as driving electrodes, and the other of the first electrodes and the second electrodes serve as sensing electrodes. The touch sensing control circuit is configured to provide driving signal to the driving electrodes in the touch sensing period, and receive sensing capacitances generated by the sensing electrodes. The time controller outputs synchronous control signals. The synchronous control signals include a display synchronous signal and a row synchronous signal. In a cycle of the row synchronous signal, the display panel completes a scan operation of one row. In a cycle of the display synchronous signal, all of rows of an image of the display panel are scanned. The touch sensing control circuit is further configured to execute a synchronous process between the driving signal and the synchronous control signals, for stopping refreshing the display image while the touch sensing period, and the touch sensing control circuit further provides the driving signals to the driving electrodes simultaneously. The driving signals are in-phase signals. The in-phase signals are pulse signals in a same frequency, a same phase, and a same amplitude.

Besides, for achieving the foregoing aim, the present application further provides a touch sensing method, applied in a capacitive touch display apparatus. The capacitive touch display apparatus includes a touch panel, a display panel, a touch sensing control circuit, and a time controller. The touch panel includes a cover plate and a touch electrode layer, which are overlapped in that order. The touch electrode layer is patterned into a plurality of first electrodes arranged along a first direction and a plurality of second electrodes arranged along a second direction. The touch sensing control circuit is electrically connected with the first electrodes and the second electrodes. In a touch sensing period, one of the first electrodes and the second electrodes serve as driving electrodes, and the other of the first electrodes and the second electrodes serve as sensing electrodes. The touch sensing control circuit is configured to provide driving signal to the driving electrodes in the touch sensing period. The touch sensing method includes:
Obtaining synchronous control signals from the time controller; the synchronous control signals includes a display synchronous signal and a row synchronous signal; in a cycle of the row synchronous signal, the display panel completes a scan operation of one row, in a cycle of the display synchronous signal, all of rows of an image of the display panel are scanned;
Executing a synchronous process between the driving signal and the synchronous control signals, for stopping refreshing the display image while the touch sensing period;
Providing driving signals to the driving electrodes simultaneously, receiving sensing capacitances of the sensing electrodes, and converting the sensing capacitances into digital signals; the driving signals are periodically in-phase signals; the in-phase signals are pulse signals with a same frequency, a same phase, and a same amplitude.

The foregoing capacitive touch display apparatus and the touch sensing method, by executing the synchronous process between driving signal and the synchronous control signals, for maintaining the display image being unchanged in the touch sensing period, the signal distribution between the touch electrode layer and the display panel is reduced, therefore the screen flicker or Moire phenomena in the display image of the capacitive touch display apparatus are avoided.

### BRIEF DESCRIPTION OF THE DRAWINGS

To illustrate the technical solutions in the embodiments of the present invention or in the prior art more clearly, accompanying drawings need for describing the embodiments or the prior art are briefly introduced in the following. Obviously, the accompanying drawings in the following description are only some embodiments of the present invention, and person of ordinary skill in the art may obtain other accompanying drawings from these accompanying drawings without making creative efforts.

FIG. 1 is a schematic view of a capacitive touch display apparatus of an exemplary embodiment of the present application.

FIG. 2 is a block schematic view of the capacitive touch display apparatus of FIG. 1 of an exemplary embodiment of the present application.

FIG. 3 is a cross-sectional schematic view of the capacitive touch display apparatus of FIG. 1, taken along III-III direction, of an exemplary embodiment of the present application.

FIG. 4 is a schematic view of digital signals corresponding to the sensing electrodes of FIG. 2 under a no-touch situation.

FIG. 5 is a schematic view of digital signals corresponding to the sensing electrodes of FIG. 2 under a touch situation.

FIG. 6 is waveforms of the display synchronous signal and driving signals of FIG. 2.

FIG. 7 is waveforms of the row synchronous signal and driving signals of FIG. 2.

FIG. 8 is waveforms of the display synchronous signal, the row synchronous signal, and the driving signals of FIG. 2.

FIG. 9 is a flowchart of a touch sensing method of an exemplary embodiment of the present application.

FIG. 10 is a detail flowchart of the block S92 of FIG. 9.

Description of symbols for main components

| | |
|---|---|
| Capacitive touch display apparatus | 1 |
| Touch panel | 10 |
| Display panel | 20 |
| Cover plate | 11 |
| Touch electrode layer | 12 |
| First display electrode layer | 21 |
| Light emitting layer | 22 |
| Second display electrode layer | 23 |
| Dielectric layer | 24 |
| First electrodes | 121_1~121_m |
| Second electrodes | 123_1~123_n |
| Driving electrodes | TX_1~TX_5 |
| Sensing electrodes Ï | RX_1~RX_10 |
| Touch display region | 101 |
| Non-display region | 103 |
| Touch sensing control circuit | 30 |
| Touch sensing line | 301 |
| Synchronous signal process module | 31 |
| Control module | 32 |
| First multiplexer module | 33 |
| Second multiplexer module | 34 |
| Touch driving module | 35 |
| Touch sensing module | 36 |
| Digital signal process module | 37 |
| Time controller | 40 |
| Touch sensing period | Ts |
| Predefined time duration | T |
| Steps | S91~S94 |

The present disclosure will be further described by the following specific embodiments in conjunction with the above figures.

### DETAILED DESCRIPTION

The present disclosure is described with reference to accompanying drawings and the embodiments. It will be understood that the specific embodiments described herein are merely part of all embodiments, not all the embodiments. Based on the embodiments of the present disclosure, it is understandable to a person skilled in the art, any other embodiments obtained by persons skilled in the art without creative effort shall all fall into the scope of the present disclosure.

Terms “first”, “second”, and “third”, and the like used in the specification, the claims, and the accompanying drawings of the present disclosure are used to distinguish different objects rather than describe a particular order. Besides, a term “comprise” and its variations are intended to cover a non-exclusive inclusion.

Unless otherwise specified, all technical and scientific terms have the ordinary meanings as understood by people skilled in the art. The terms used in this disclosure are illustrative rather than limiting. Terms “and/or” used in the specification, includes any and all combinations of one or more of the associated listed terms.

The detail embodiment of a capacitive touch display apparatus and a touch sensing method of the present application will be described with reference to accompanying drawings as follow.

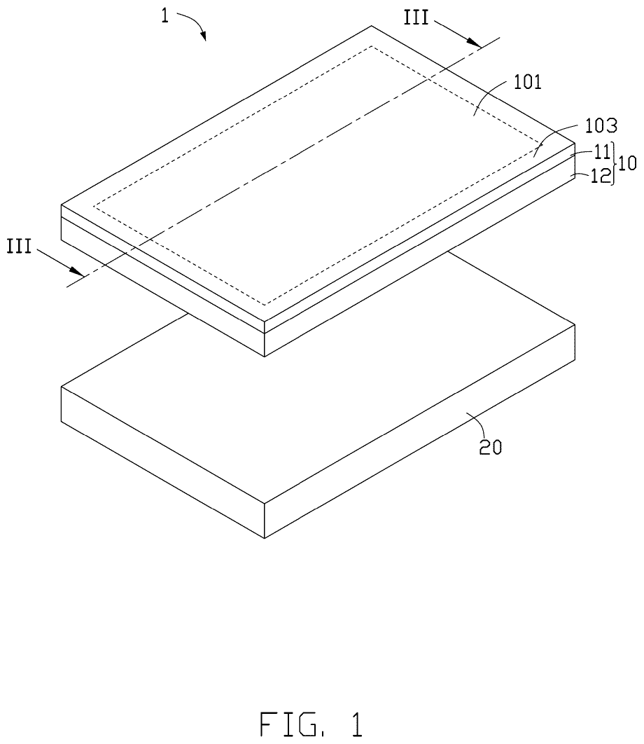

Referring to FIG. 1, FIG. 1 shows a schematic view of a capacitive touch display apparatus 1 of an exemplary embodiment of the present application. In at least one embodiment of the present application, the capacitive touch display apparatus 1 may be a removable device, such as a personal computer, a planet, a mobile phone, a personal digital assistance (PDA), a game machine, an Internet protocol television (IPTV), a smart wearable device, a navigation apparatus, and so on. The capacitive touch display apparatus 1 may further include one or more functions, such as fingerprint identification function, a display function, and a camera function.

The capacitive touch display apparatus 1 includes a touch panel 10 and a display panel 20.

The touch panel 10 is configured to sense touch operations of users. The touch panel 10 includes a cover plate 11 and a touch electrode layer 12, which are overlapped from upper to lower in that order.

The cover plate 11 may be a glass substrate, or a transparent substrate with a higher intensity and a higher hardness. In one embodiment of the present application, a material of the cover plate 11 may be polycarbonate (PC), polyethylene terephthalate (PET), polymethylmethacrylate (PMMA), cyclic olefin copolymer (COC), or polyether sulfone (PES), and the like.

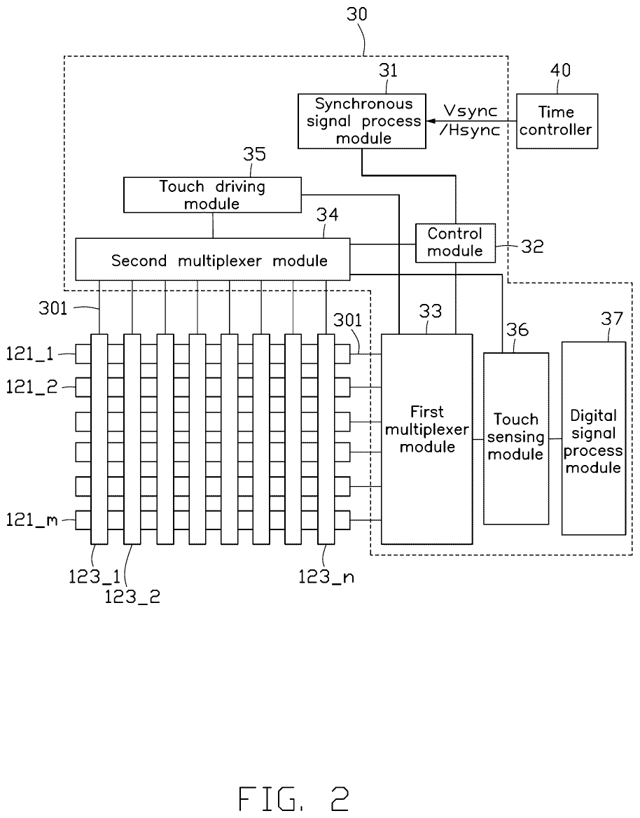

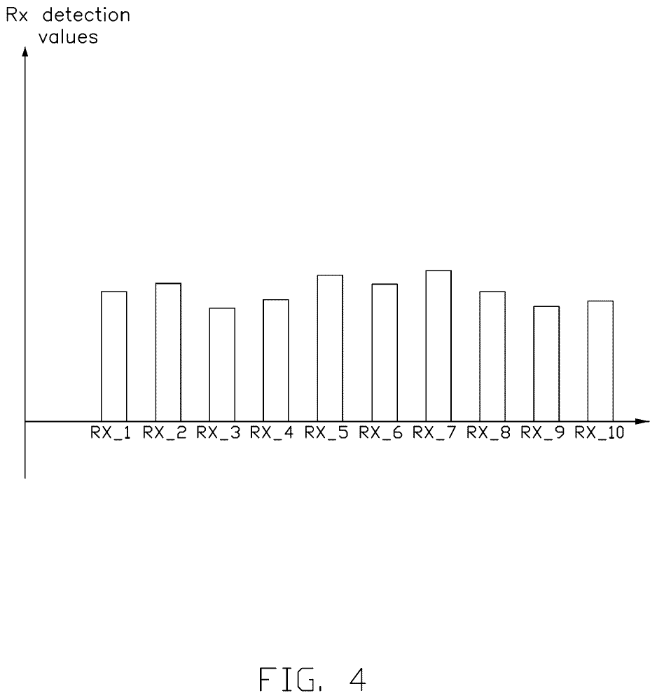

Referring to FIG. 2 together, which is a schematic view of the touch electrode layer 12. The touch electrode layer 12 is made of conductive material, and is patterned into a plurality of first electrodes 121_1~121_m and a plurality of second electrodes 123_1~123_n, m and n are positive integer, which may be same or different from each other. The plurality of first electrodes 121_1~121_m are extended along a first direction X and are parallel with each other. The plurality of second electrodes 123_1~123_n are extended along a second direction Y and are parallel with each other. In one embodiment of the present application, the first direction X is perpendicular to the second direction Y In other embodiments, the first direction X and the second direction Y may be set and crossed in other angles. In any time of a touch sensing period Ts (as shown in FIGS. 4 to 6), one of the first electrodes 121_1~121_m and the second electrodes 123_1~123_n serve as driving electrodes, and others of the first electrodes 121_1~121_m and the second electrodes 123_1~123_n serve as sensing electrodes. When there is a grounding conductor existed on the cover plate 11, sensing capacitances are generated between the sensing electrodes and the grounding conductor. In one embodiment of the present application, the touch electrode layer 12 may be a single conductive structure, for forming a self-capacitor touch sensing structure. In other embodiments, the touch electrode layer 12 further may be multiple-layer conductive structure, for forming a mutual capacitance touch sensing structure.

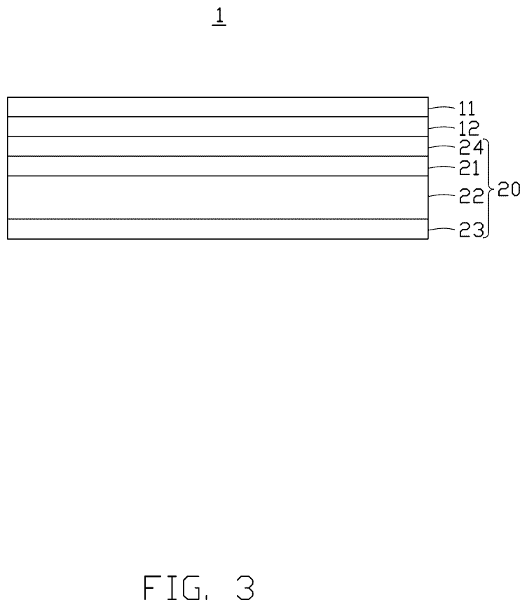

Referring to FIG. 3 together, which is a cross-sectional schematic view of the display panel 20, taken along III-III direction. The display panel 20 is disposed below the touch panel 10, and is configured to display images. The display panel 20 includes a first display electrode 21, a light-emitting layer 22, a second display electrode layer 23, and a dielectric layer 24. In one embodiment of the present application, the display panel 20 is a flexible active matrix organic light emitting diode (AMOLED). In other embodiments, the display panel 20 further may be other types of display panel, such as a liquid crystal display panel, a field emission display panel, a plasma display panel, and an electrophoretic display panel.

The first display electrode layer 21 is disposed on a side of the dielectric layer 24 away from the touch electrode layer 12. The first display electrode layer 21 may be patterned into a plurality of first display electrodes (such as cathode electrodes). The light-emitting layer 22 is disposed between the first display electrode layer 21 and the second display electrode layer 23, and is disposed on a side of the first display electrode layer 21 away from the dielectric layer 24. The light-emitting layer 22 is configured to emit light while a driving voltage is applied on the first display electrode layer 21 and the second display electrode layer 23. In one embodiment of the present application, the light-emitting layer 22 may further include a hole injection layer (HIL), a hole transport layer (HTL), an emitting layer (EML), and an electronic transport layer (ETL). The second display electrode layer 23 is disposed on a side of the light-emitting layer 22 away from the first display electrode layer 21.

Further, referring to FIGS. 1 and 2, the capacitive touch display apparatus 1 defines a touch display region 101 and a non-display region 103 surrounding the touch display region 101. The plurality of first electrodes 121_1~121_m and the plurality of second electrodes 123_1~123_n are disposed in the touch display region 101, and extends into the non-display region 103.

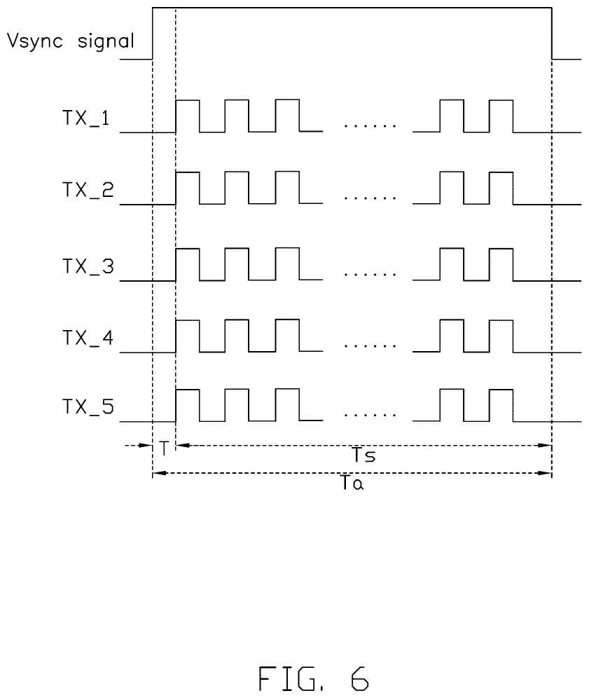

Referring to FIG. 2, the capacitive touch display apparatus 1 further includes a touch sensing control circuit 30 and a time controller 40. The touch sensing control circuit 30 may be disposed in the non-display region 103, and are electrically connected with the plurality of first electrodes 121_1~121_m and the plurality of second electrodes 123_1~123_n through touch sensing lines 301. The touch sensing control circuit 30 is configured to output driving signals to the driving electrodes in a touch sensing period Ts (as shown in FIGS. 6 to 8), and calculate capacitances of each of sensing capacitors formed by the sensing electrodes. Further, the touch sensing control circuit 30 executes a synchronous process between synchronous control signals generated by the time controller 40 and the driving signal. After the synchronous process, in the touch sensing period Ts, the display panel 20 stops refreshing the display image.

The touch sensing control circuit 30 includes a synchronous signal process module 31, a control module 32, a first multiplexer module 33, a second multiplexer module 34, a touch driving module 35, a touch sensing module 36, and a digital signal process module 37.

The synchronous signal process module 31 is electrically connected with the time controller 40 and the control module 32. The synchronous signal process module 31 identifies synchronous control signals outputted by the time controller 40 at a starting time and an ending time in one cycle and outputs to the control module 32. The synchronous control signals are periodically pulse signals. The starting time is a time when a rising edge of the synchronous control signal generates in one cycle, and the ending time is a time when a falling edge of the synchronous control signal in one cycle. In one embodiment of the present application, the synchronous control signals includes a display synchronous signal Vsync and a row synchronous signal Hsync. In one cycle of the display synchronous signal Vsync, the display panel 20 completes a scanning operation of a frame image. In one cycle of the row synchronous signal Hsync, the display panel 20 completes a scanning operation of a row image. In one cycle of the display synchronous signal Vsync, the number of the cycles of the row synchronous signal Hsync is equal to the number of rows of the display panel 20. In that means, in one cycle of the display synchronous signal Vsync, the operation of scanning all rows of the image of the display panel 20 is completed. The synchronous signal process module 31 identifies the starting time and the ending time of one of the display synchronous signal Vsync and row synchronous signal Hsync.

The control module 32 is electrically connected with the synchronous signal process module 31, the first multiplexer module 33, and the second multiplexer module 34. The control module 32 outputs a state setting signal after a predefined time duration T, which starts from the starting time to the first multiplexer module 33 and the second multiplexer module 34, for controlling one of the first multiplexer module 33 and the second multiplexer module 34 to switch to a first state, and controlling another one of first multiplexer module 33 and the second multiplexer module 34 to switch to a second state. In one embodiment of the present application, the control module 32 controls the first multiplexer module 33 and the second multiplexer module 34 to be the first state alternately according to the state setting signal. For example, the touch sensing period Ts may include at least one first time duration and at least one second time duration, which are disposed alternately. In the first time duration, the control module 32 controls the first multiplexer module 33 to switch to the first state and controls the second multiplexer module 34 to switch to the second state according to the state setting signal, thus the first electrodes 121_1~121_m are served as the driving electrodes, the second electrodes 123_1~123_n are served as sensing electrodes. In the second time duration, the control module 32 controls the first multiplexer module 33 to the second state and controls the second multiplexer module 34 to the first state according to the state setting signal, thus the first electrodes 121_1~121_m are served as the sensing electrodes, the second electrodes 123_1~123_n are served as driving electrodes.

The first multiplexer module 33 is electrically connected with the first electrodes 121_1~121_m, the control module 32, the touch driving module 35, and the touch sensing module 36. The first multiplexer module 33 may be switched between the first state and the second state. In the first state, the first multiplexer module 33 establishes electrical connections between the touch driving module 35 and the first electrodes 121_1~121_m, for setting the first electrodes 121_1~121_m as the driving electrodes. In the second state, the first multiplexer module 33 establishes electrical connections between the touch sensing module 35 and the first electrodes 121_1~121_m, for setting the first electrodes 121_1~121_m as the sensing electrodes.

The second multiplexer module 34 is electrically connected with the second electrodes 123_1~123_n, the control module 32, the touch driving module 35, and the touch sensing module 36. The second multiplexer module 34 may be switched between the first state and the second state. In the first state, the second multiplexer module 34 establishes electrical connections between the touch driving module 35 and the second electrodes 123_1~123_n, for setting the second electrodes 123_1~123_n as the driving electrodes. In the second state, the second multiplexer module 34 establishes electrical connections between the touch sensing module 35 and the second electrodes 123_1~123_n, for setting the second electrodes 123_1~123_n as the sensing electrodes.

The touch driving module 35 is electrically connected with the first multiplexer module 33 and the second multiplexer module 34. The touch driving module 35 is configured to output driving signals to the driving electrodes through the first multiplexer module 33 or the second multiplexer module 34 in the first state. The driving signals are periodically in-phase signals. In one embodiment of the present application, the in-phase signals are pulse signals with a same frequency, a same phase, and a same amplitude. It is understood that, the same phase and the same amplitude may exist a light deviation due to a signal loss or other reasons, but the frequency must be same.

The touch sensing module 36 is electrically connected with the first multiplexer module 33 and the second multiplexer module 34. The touch sensing module 36 is configured to calculate capacitances of each of sensing capacitors transmitted by the first multiplexer module 33 or the second multiplexer module 34 at the second state, and convert the capacitances into digital signal to the digital signal process module 37.

The digital signal process module 37 is electrically connected with the touch sensing module 36. The digital signal process module 37 is configured to analyze the digital signal to obtain a touch position of a touch object on the capacitive touch display apparatus 1. In one embodiment, the digital signal process module 37 calculates a difference between the digital signal and a standard signal, and calculate the touch position of the touch object on the capacitive touch display apparatus 1 based on the difference using a barycenter algorithm. The standard signal is a value of the digital signal being converted by the sensing capacitance of the first electrodes 121_1~121_m or the second electrodes 123_1~123_n under a no-touch situation. The barycenter algorithm may be weighted and averaged by an arrangement number of the first electrodes 121_1~121_m or the second electrodes 123_1~123_n and the difference.

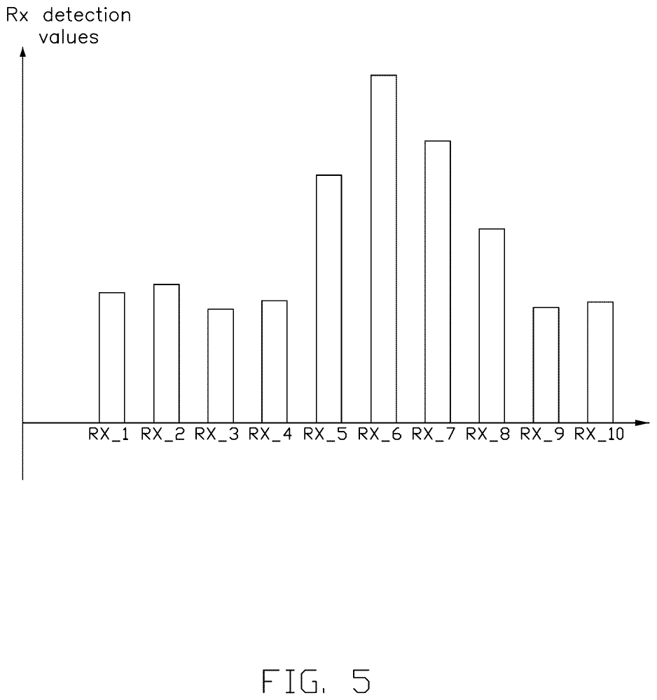

Referring to FIGS. 4 and 5, the digital signals corresponding to the sensing electrodes RX_1~RX_10 under the no-touch situation and under a touch situation. Under the no-touch situation, the difference between the digital signals corresponding to the sensing electrodes RX_1~RX_10 are not obvious. Under the touch situation, the digital signals corresponding to the sensing electrodes RX_5~RX_8 are gradually increased. Therefore, the touch position of the touch object on the capacitive touch display apparatus 1 corresponds to the position corresponding to the sensing electrodes RX_5~RX_8.

In detail, when the first multiplexer module 33 is at the first state, and the second multiplexer module 34 is at the second state, the touch driving module 35 is configured to output the driving signal to the first electrodes 121_1~121_m, the touch sensing module 36 calculates the capacitances of sensing capacitors formed by the second electrodes 123_1~123_n. The digital signal process module 37 calculates changes of the capacitances of each of the second capacitors, and obtains a X coordinate of the touch object along the first direction X based on the changes of the sensing capacitances.

When the first multiplexer module 33 is at the second state, and the second multiplexer module 34 is at the first state, the touch driving module 35 is configured to output the driving signal to the second electrodes 123_1~123_n, the touch sensing module 36 calculates the capacitances of the sensing electrodes formed by the first electrodes 121_1~121_m. The digital signal process module 37 calculates capacitance changes in each of the sensing electrodes formed by the first electrodes 121_1~121_m, and obtains a Y coordinate of the touch object along the second direction Y based on the capacitance changes of each of the sensing capacitors.

The digital signal process module 37 uses the coordinates on the first direction X and the second direction Y as the two-dimensional coordinates of the touch object on the capacitive touch display apparatus 1, thus the position of the touch object on the capacitive touch display apparatus 1 is obtained.

In some embodiments, a part of the driving electrodes may be grounded or in a floating state, other of the driving electrodes remains receiving the driving signals. The driving electrodes being grounded or in the floating state do not affect functions of other driving electrodes or sensing electrodes.

In some embodiments, the touch sensing control circuit 30 may calculate the capacitances of the sensing capacitors in a time-division manner. Under this model, a cost of the capacitive touch sensing apparatus 1 is low, but ages of the signal sensing is slow. Simultaneously, a part of the driving electrodes may be grounded, receiving the driving signal, or in a floating state. The driving electrodes being grounded or in the floating state do not affect functions of other driving electrodes or sensing electrodes.

The foregoing capacitive touch display apparatus 1, by executing the synchronous process between driving signal and the synchronous control signals generated by the time controller 40, for maintaining the display image being unchanged in the touch sensing period, the signal distribution between the touch electrode layer and the display panel is reduced, therefore the screen flicker or Moire phenomena in the display image of the capacitive touch display apparatus are avoided.

### First Embodiment

Referring to FIG. 6, which is waveforms of the display synchronous signal Vsync and driving signals corresponding to the driving electrodes TX_1~TX_5. In the first embodiment, the synchronous signal process module 31 identifies the starting time and the ending time of the display synchronous signal Vsync, and outputs to the control module 32. The control module 32 sets the state setting signal to output to the first multiplexer module 33 and the second multiplexer module 34 after the predefined time duration T, which starts from the starting time, for controlling one of the first multiplexer module 33 and the second multiplexer module 34 to switch to the first state, and controlling another one of the first multiplexer module 33 and the second multiplexer module 34 to switch to the second state. The time duration Ta between the starting time and the ending time is greater than the predefined time duration T. In the time duration Ta between the starting time and the ending time, the display synchronous signal Vsync is maintained at a high voltage level. After the predefined time duration T, the touch sensing control circuit 30 outputs the plurality of driving signals to the driving electrodes, and stops outputting the plurality of the driving signals to the driving electrodes before the ending time of the display synchronous signal Vsync. The driving signals with the same frequency, the same phase, and the same amplitude, are constructed into the in-phase signals. In the touch sensing period Ts, the display synchronous signal Vsync does not refresh, thus the display image of the display panel 20 is maintained at unchanged. The signal distribution between the touch electrode layer 12 and the display panel 20 in the capacitive touch display apparatus 1 is reduced, and the screen flicker or Moire phenomena in the display image of the capacitive touch display apparatus are avoided. Besides, the time duration Ta between the starting time and the ending time, the touch driving module 35 outputs the driving signals twice, for obtaining the coordinates of the touch position, a touch sensing efficiency of the capacitive touch display apparatus 1 is improved, and the capacitive touch display apparatus 1 has a lower reaction delay and a lower power dissipation.

### Second Embodiment

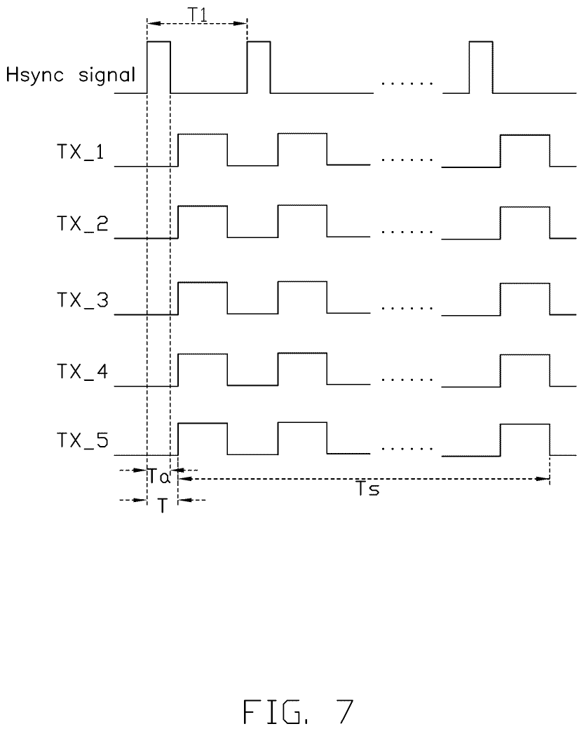

Referring to FIG. 7 together, which are waveforms of the row synchronous signal Hsync and the driving signals corresponding to the driving electrodes TX_1~TX_5. In the second embodiment, the synchronous signal process module 31 identifies the starting time and the ending time of the row synchronous signal Hsync, and outputs to the control module 32. The control module 32 sets the state setting signal to output to the first multiplexer module 33 and the second multiplexer module 34 after the predefined time duration T, which starts from the starting time, for controlling one of the first multiplexer module 33 and the second multiplexer module 34 to switch to the first state, and controlling another one of the first multiplexer module 33 and the second multiplexer module 34 to switch to the second state. The time duration Ta between the starting time and the ending time is less than the predefined time duration T. That is, in the touch sensing period Ts, the row synchronous signal Hsync is maintained at the low voltage level. In that means, in the touch sensing period Ts, the row synchronous signal Hsync does not refresh, for remaining the display image of the display panel 20 unchanged. Beside, in one cycle of the row synchronous signal Hsync, the touch driving module 35 merely transmit the driving signals once. After the predefined time duration T, the touch sensing control circuit 30 outputs several driving signals to the driving electrodes. Before a next starting time of the row synchronous signal Hsync, the touch sensing control circuit 30 stops outputting the driving signals to the electrodes. Under a condition of a change frequency of the display synchronous signal Vsync, the capacitive touch display apparatus 1 executes a synchronous process between the driving signals and the row synchronous signal Hsync, which reduces a difficulty in the synchronous process of the driving signals and the row synchronous signal Hsync. The signal distribution between the touch electrode layer 12 and the display panel 20 in the capacitive touch display apparatus 1 is reduced, and the screen flicker or Moire phenomena in the display image of the capacitive touch display apparatus are avoided.

### Third Embodiment

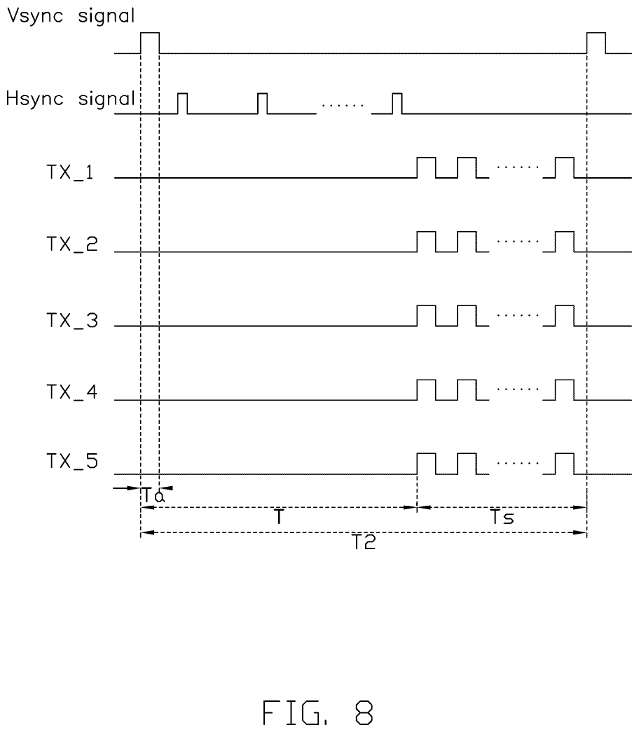

Referring to FIG. 8 together, which are waveforms of the display synchronous signal Vsync, the row synchronous signal Hsync, and the driving signal corresponding to the driving electrodes TX_1~TX_5. In the third embodiment, the synchronous signal process module 31 identifies the starting time and the ending time of the display synchronous signal Vsync and outputs to the control module 32. The control module 32 sets the state setting signal to output to the first multiplexer module 33 and the second multiplexer module 34 after the predefined time duration T, which starts from the starting time, for controlling one of the first multiplexer module 33 and the second multiplexer module 34 to switch to the first state, and controlling another one of the first multiplexer module 33 and the second multiplexer module 34 to switch to the second state. The time duration Ta between the starting time and the ending time is less than the predefined time duration T. In the time duration Ta between the starting time and the ending time, the display synchronous signal Vsync is maintained at a high voltage level. In the touch sensing period Ts, both of the display synchronous signal Vsync and the row synchronous signal Hsync are maintained at the low voltage level state. In other words, in the touch sensing period Ts, the row synchronous signal Hsync does not refresh, thus the display image of the display panel 20 is maintained at unchanged. After the predefined time duration T, the touch sensing control circuit 30 outputs the plurality of driving signals to the driving electrodes, and stops outputting the plurality of the driving signals to the driving electrodes before a next starting time of the display synchronous signal Vsync. The driving signals with the same frequency, the same phase, and the same amplitude, are constructed into the in-phase signals. In the third embodiment, in the predefined time duration T, the display panel 20 completes a scanning process of a frame image. After the predefined time duration T, the display panel 20 remains the current display image, and stops executing the scanning process of a next frame image. The capacitive touch display apparatus 1 reduces the signal distribution between the touch electrode layer 12 and the display panel 20 while the touch sensing period Ts, the screen flicker or Moire phenomena in the display image of the capacitive touch display apparatus 1 are avoided. Besides, in any cycle T2 of the display synchronous signal Vsync, the touch driving module 35 transmits the synchronous driving signals, for improving a touch sensing efficiency of the capacitive touch display apparatus 1, which cause the capacitive touch display apparatus 1 having a lower reaction delay and a lower power dissipation.

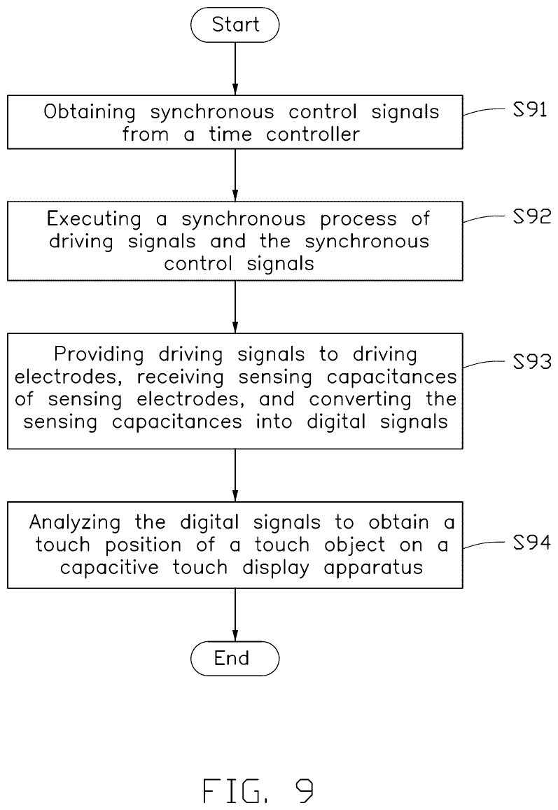

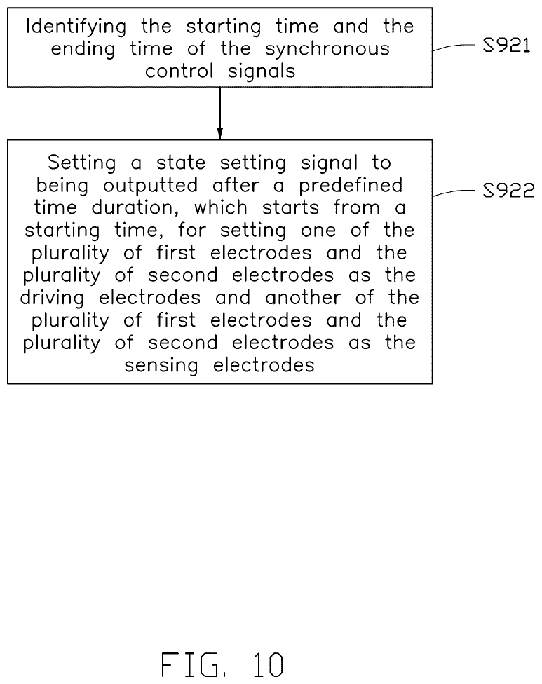

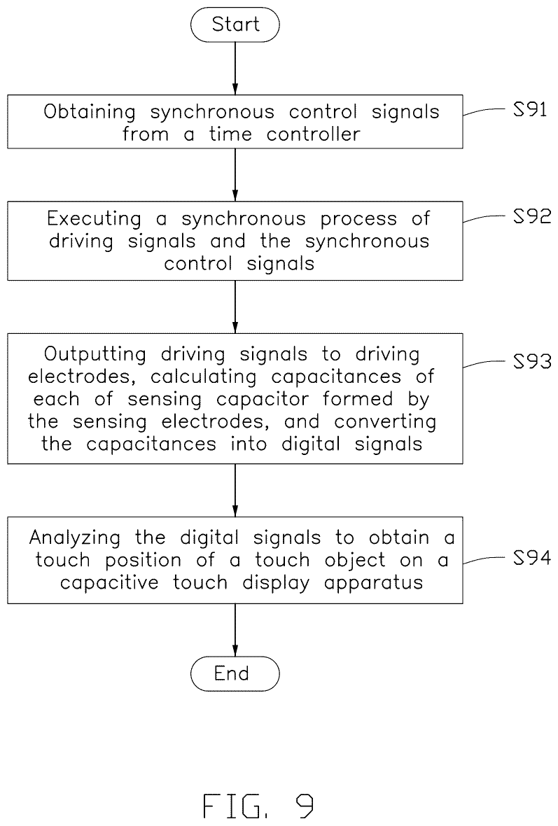

Referring to FIG. 9, which is a flowchart of the touch sensing method. In one embodiment of the present application, the touch sensing method is applied to the capacitive touch display apparatus 1. The touch sensing method includes following steps.

In block S91, synchronous signals are obtained from the time controller 40.

In one embodiment, the synchronous signals include the display synchronous signal Vsync and the row synchronous signal Hsync. In one cycle of the display synchronous signal Vsync, the display panel 20 completes the scanning operation of the row image. In one cycle of the display synchronous signal Vsync, the number of the cycles of the row synchronous signal Hsync is equal to the number of rows of the display panel 20. In that means, in one cycle of the display synchronous signal Vsync, the operation of scanning all rows of the image of the display panel 20 is completed. The synchronous signal process module 31 identifies the starting time and the ending time of one of the display synchronous signal Vsync and row synchronous signal Hsync.

In block S92, a synchronous process is executed between the driving signals and the synchronous control signals.

Referring to FIG. 10 together, in one embodiment of the present application, the step of executing the synchronous process between the driving signals and the synchronous control signals includes:

In block S921, a starting time and an ending time of the synchronous control signals are identified.

In one embodiment of the present application, the starting time is a time when a rising edge of the synchronous control signal generates in one cycle, and the ending time is a time when a falling edge of the synchronous control signal in one cycle.

In block S922, a state setting signal is set to be outputted after a predefined time duration T, which starts from the starting time, for setting one of the plurality of first electrodes 121_1~121_m and the plurality of second electrodes 123_1~123_n as driving electrodes and another of the plurality of first electrodes 121_1~121_m and the plurality of second electrodes 123_1~123_n as sensing electrodes.

In a first embodiment, when the synchronous signal is a display synchronous signal Vsync, a first time duration Ta between the starting time and the ending time is larger than the predefined time duration T. That is, in the time duration Ta between the starting time and the ending time, the display synchronous signal Vsync is maintained at a high voltage level. After the predefined time duration T, the plurality of driving signals are outputted to the driving electrodes, and are stopped to being outputted to the driving electrodes before the ending time of the display synchronous Vsync. The plurality of driving signals with the same frequency, the same phase, and the same amplitude, are constructed into the in-phase signals. That is, in the touch sensing period Ts, the display synchronous signal Vsync does not refresh, the display image of the display panel 20 is maintained at unchanged. Therefore, the capacitive touch display apparatus 1 reduces a signal distribution between the touch electrode layer 12 and the display panel 20 while the touch sensing period Ts, the screen flicker or Moire phenomena in the display image of the capacitive touch display apparatus are avoided. Besides, the time duration Ta between the starting time and the ending time, the touch driving module 35 transmits the driving signals for several times, for improving a touch sensing efficiency of the capacitive touch display apparatus 1, which makes the capacitive touch display apparatus 1 having a lower reaction delay and a lower power dissipation.

In a second embodiment, when the synchronous signal is a row synchronous signal Hsync, a first time duration Ta between the starting time and the ending time is less than the predefined time duration T. That is, in the touch sensing period Ts, the row synchronous signal Hsync is maintained at a low voltage level. In that means, the touch sensing period Ts, the row synchronous signal Hsync does not refresh, for making the display image of the display panel 20 to be unchanged. In the predefined time duration T, the plurality of driving signals are outputted to the driving electrodes, and are stopped to being outputted to the driving electrodes before the ending time of the row synchronous Hsync. The plurality of driving signals with the same frequency, the same phase, and the same amplitude, are constructed into the in-phase signals. Besides, in a cycle T1 of the row synchronous signal Hsynce, the touch driving module 35 only transmit the driving signal once. Under a condition of a change frequency of the display synchronous signal Vsync, the capacitive touch display apparatus 1 executes a synchronous process between the driving signals and the row synchronous signal Hsync, which reduces a difficulty in the synchronous process of the driving signals and the row synchronous signal Hsync. The signal distribution between the touch electrode layer 12 and the display panel 20 in the capacitive touch display apparatus 1 is reduced, and the screen flicker or Moire phenomena in the display image of the capacitive touch display apparatus are avoided.

In a third embodiment, the synchronous signals include the display synchronous signal Vsync and the row synchronous signal Hsynce. The time duration Ta between the starting time and the ending time is less than the predefined time duration T. That is, the time duration Ta between the starting time and the ending time, the display synchronous signal Vsync is maintained at the high voltage level. After the predefined time duration T, the plurality of driving signals are outputted to the driving electrodes, and are stopped to being outputted to the driving electrodes before a next starting time of the display synchronous signal Vsync. The driving signals with the same frequency, the same phase, and the same amplitude, are constructed into the in-phase signals. In the touch sensing period Ts, both of the display synchronous signal Vsync and the row synchronous signal Hsync are maintained at a low voltage level state. In other words, in the touch sensing period Ts, the row synchronous signal Hsync does not refresh, the display image of the display panel 20 is maintained at unchanged. In the third embodiment, in the predefined time duration T, the display panel 20 completes a scanning process of a frame image. After the predefined time duration T, the display panel 20 remains the current display image, and stops executing the scanning process of a next frame image. Thus, the capacitive touch display apparatus 1 reduces a signal distribution between the touch electrode layer 12 and the display panel 20 while the touch sensing period Ts, the screen flicker or Moire phenomena in the display image of the capacitive touch display apparatus 1 are avoided. Besides, in any cycle T2 of the display synchronous signal Vsync, the touch driving module 35 transmits the synchronous driving signals, for improving a touch sensing efficiency of the capacitive touch display apparatus 1, which makes the capacitive touch display apparatus 1 having a lower reaction delay and a lower power dissipation.

In block S93, the driving signals are outputted to the driving electrodes, capacitances of each of sensing capacitors formed by the sensing electrodes are calculated, the capacitances are converted into digital signals.

The driving signals corresponding to different driving electrodes are periodically in-phase signals. In one embodiment of the present application, the in-phase signals are pulse signals with a same frequency, a same phase, and a same amplitude. It is understood that, the same phase and the same amplitude may exist a light deviation due to a signal loss or other reasons, but the frequency must be same.

In block S94, the digital signals are analyzed to obtain a touch position of a touch object on the capacitive touch display apparatus 1.

In one embodiment of the present application, a difference between the digital signal and a standard signal is calculated, and the touch position of the touch object on the capacitive touch display apparatus 1 is calculated based on the difference using a barycenter algorithm. The standard signal is a value of the digital signal being converted by the sensing capacitance of the sensing electrodes under a no-touch situation. The barycenter algorithm may be weighted and averaged by an arrangement number of the sensing electrodes and the difference.

Based on the foregoing touch sensing method, by executing the synchronous process between driving signal and the synchronous control signals generated by the time controller 40, for maintaining the display image being unchanged in the touch sensing period, the signal distribution between the touch electrode layer and the display panel is reduced, therefore the screen flicker or Moire phenomena in the display image of the capacitive touch display apparatus are avoided.

Based on above, the foregoing described embodiments are only exemplary embodiments of this application, and are not intended to limit the scope of this application. Without departing from design spirit of this application, various transformations and improvements made by a person of ordinary skill in the art to the technical solutions of this application shall fall within the protection scope defined in claims of this application.

1. A capacitive touch display apparatus, comprising a touch panel, a display panel, a touch sensing control circuit, and a time controller; the touch panel comprises a touch electrode layer; the touch electrode layer is patterned into a plurality of first electrodes disposed along a first direction and a plurality of second electrodes disposed along a second direction, the touch sensing control circuit is electrically connected with the plurality of first electrodes and the plurality of second electrodes; wherein in a touch sensing period, the plurality of first electrodes and the plurality of second electrodes are configured to be sensing electrodes and driving electrodes alternately; the touch sensing control circuit is configured to output driving signals to the driving electrodes in the touch sensing period, and calculate capacitances of each of sensing capacitors formed by each of the sensing electrodes; the time controller outputs synchronous control signals; the synchronous control signals comprises a display synchronous signal and a row synchronous signal; in a cycle of the row synchronous signal, the display panel completes a scanning operation of a row image, in a period of the display synchronous signal, image scan of all rows of image in the display panel are completed; the touch sensing control circuit is further configured to execute a synchronous process of the driving signals and the synchronous control signals, thereby the synchronous process causes the display panel to stop refreshing a display image of the display panel in the touch sensing period, and the touch sensing control circuit further outputs the driving signals to the driving electrodes simultaneously; wherein the driving signals are periodically in-phase signals, the in-phase signals are pulse signals with a same frequency, a same phase, and a same amplitude.

2. The capacitive touch display apparatus of claim 1, wherein the touch sensing control circuit comprises a synchronous signal process module, a control module, a first multiplexer module, a second multiplexer module, a touch driving module, and a touch sensing module; the synchronous signal process module identifies a starting time and an ending time of each of the synchronous control signals in one cycle, and provides to the control module; the control module outputs a state setting signal to the first multiplexer module and the second multiplexer after a predefined time duration, the predefined time duration starts from the starting time, the state setting signal is configured to control one of the first multiplexer and the second multiplexer to switch to a first state, and another one of the first multiplexer and the second multiplexer to switch to a second state; wherein in the first state, the first multiplexer establishes electrical connections between the touch driving module and the first electrodes, thereby setting the first electrodes as the driving electrodes; in the second state, the first multiplexer module establishes electrical connections between the touch driving module and the first electrodes, thereby setting the first electrodes as the sensing electrodes; in the first state, the second multiplexer establishes electrical connections between the touch driving module and the second electrodes, thereby setting the first electrodes as the sensing electrodes; in the second state, the first multiplexer module establishes electrical connections between the touch driving module and the first electrodes, thereby setting the first electrodes as the driving electrodes.

3. The capacitive touch display apparatus of claim 2, wherein the synchronous signal process module identifies a starting time and an ending time in one cycle of the display synchronous signal; a time duration between the starting time and the ending time in one cycle of the display synchronous signal is greater than the predefined time duration; in the time duration between the starting time and the ending time of one cycle of the display synchronous signal, the display synchronous signal is maintained at a high voltage level; after the predefined time duration, the touch sensing control circuit outputs the driving signals to the driving electrodes, and the touch sensing control circuit stops outputting the driving signals to the driving electrodes before the ending time of the display synchronous signal.

4. The capacitive touch display apparatus of claim 2, wherein the synchronous signal process module further identifies a starting time and an ending time in one cycle of the row synchronous signal; a time duration between the starting time and the ending time in one cycle of the row synchronous signal is less than the predefined time duration; in the time duration between the starting time and the ending time in one cycle of the row synchronous signal, the row synchronous signal is maintained at a low voltage level; after the predefined time duration, the touch sensing control circuit outputs the driving signals to the driving electrodes, and the touch sensing control circuit stops outputting the driving signals to the driving electrodes before a starting time of a next cycle of the row synchronous signal.

5. The capacitive touch display apparatus of claim 2, wherein the synchronous signal process module identifies a starting time and an ending time in one cycle of the display synchronous signal; a time duration between the starting time and the ending time of the display synchronous signal is less than the predefined time duration; in the time duration between the starting time and the ending time in one cycle of the display synchronous signal, the display synchronous signal is maintained at a high voltage level; in the touch sensing period, the display synchronous signal and the row synchronous signal are maintained at a low voltage level, after the predefined time duration, the touch sensing control circuit outputs the driving signals to the driving electrodes, and the touch sensing control circuit stops outputting the driving signals to the driving electrodes before a starting time of a next cycle of the display synchronous signal.

6. The capacitive touch display apparatus of claim 2, wherein the touch sensing period comprises at least one first time duration and at least one second time duration, the at least one first time duration and the at least one second time duration are spaced alternately; in the first time duration, the control module controls the first multiplexer module to switch to the first state and controls the second multiplexer module to switch to the second state according to the state setting signal, thereby setting the first electrodes as the driving electrodes and setting the second electrodes as the sensing electrodes; in the second time duration, the control module controls the first multiplexer module to switch to the second state and controls the second multiplexer module to switch to the first state according to the state setting signal, thereby setting the first electrodes as the sensing electrodes and setting the second electrodes as the driving electrodes.

7. A touch sensing method, applied in a capacitive touch display apparatus; the capacitive touch display apparatus comprises a touch panel, a display panel, a touch sensing control circuit, and a time controller; the touch panel comprises a touch electrode layer; the touch electrode layer is patterned into a plurality of first electrodes disposed along a first direction and a plurality of second electrodes disposed along a second direction, the touch sensing control circuit is electrically connected with the plurality of first electrodes and the plurality of second electrodes; wherein in a touch sensing period, the plurality of first electrodes and the plurality of second electrodes are configured to being driving electrodes and sensing electrodes alternately; the touch sensing control circuit is configured to output driving signals to the driving electrodes in the touch sensing period; the touch sensing method comprises:
obtaining synchronous control signals from the time controller; the synchronous control signals comprise a display synchronous signal and a row synchronous signal; in a cycle of the display synchronous signal, image scan of all rows of image in the display panel are completed;
executing a synchronous process of the driving signals and the synchronous control signals, for causing a display image of the display panel stops refreshing in the touch sensing period;
outputting the driving signals to the driving electrodes, calculating capacitances of each of sensing capacitors formed by the sensing electrodes, and converting the capacitances into digital signals; wherein the driving signals are periodically in-phase signals, the in-phase signals are pulse signals with a same frequency, a same phase, and a same amplitude; and
analyzing the digital signals to obtain a touch position of a touch object on the capacitance touch display apparatus.

8. The touch sensing method of claim 7, wherein the executing a synchronous process of the driving signals and the synchronous signal comprises:
identifying a starting time and an ending time of the synchronous control signal; and
setting a state setting signal being outputted after a predefined time duration, the predefined time duration starts from the starting time, thereby setting the plurality of first electrodes and the plurality of second electrodes as the driving electrodes and the sensing electrodes alternately.

9. The touch sensing method of claim 6, wherein when the synchronous control signal is the display synchronous signal, a starting time and an ending time in one cycle of the display synchronous signal is identified; a time duration between the starting time and the ending time in one cycle of the display synchronous signal is greater than the predefined time duration; in the time duration between the starting time and the ending time in one cycle of the display synchronous signal, the display synchronous signal is maintained at a high voltage level, thereby the display image of the display panel stops refreshing, after the predefined time duration, the driving signals are outputted to the driving electrodes, and are stopped to being outputted to the driving electrodes before the ending time of in a same cycle of the display synchronous signal.

10. The touch sensing method of claim 8, wherein when the synchronous control signal is a row synchronous signal, a starting time and an ending time in one cycle of the row synchronous signal is identified; a time duration between the starting time and the ending time in one cycle of the display synchronous signal is less than the predefined time duration; in the time duration between the starting time and the ending time in one cycle of the display synchronous signal, the row synchronous signal is maintained at a low voltage level, thereby causing the display panel to stop refreshing a display image, after the predefined time duration, the driving signals are provided to the driving electrodes, and are stopped to being provided to the driving electrodes before a starting time of a next cycle of the row synchronous signal.

11. The touch sensing method of claim 8, wherein the synchronous control signals comprises a display synchronous signal and a row synchronous signal; the touch sensing method further identifies a starting time and an ending time of the display synchronous signal; a time duration between the starting time and the ending time in one cycle of the display synchronous signal is less than the predefined time duration; in the time duration between the starting time and the ending time in one cycle of the display synchronous signal, the display synchronous signal is maintained at a high voltage level; in the touch sensing period, the display synchronous signal and the row synchronous signal are maintained at a low voltage level, thereby the display image of the display panel stops refreshing; after the predefined time duration, the driving signals are outputted to the driving electrodes, and are stopped to being outputted to the driving electrodes before a starting time of a next cycle of the display synchronous.

12. The touch sensing method of claim 7, wherein the touch sensing period comprises at least one first time duration and at least one second time duration, the at least one first time duration and the at least one second time duration are spaced alternately; in the first time duration, the first electrodes are configured to be the driving electrodes, the second electrodes are configured to be the sensing electrodes; in the second time duration, the first electrodes are configured to be the sensing electrodes, and the second electrodes are configured to be the driving electrodes.

13. The touch sensing method of claim 7, wherein the touch sensing method further comprising:
calculating a difference between the digital signal and a standard signal; and
calculating a touch position of a touch object on the capacitive touch display apparatus based on the difference using a barycenter algorithm.

14. The capacitive touch display apparatus of claim 1, wherein the capacitive touch display apparatus further comprises a digital signal process module; the digital signal processing module analyzes the digital signal to obtain a touch position of a touch object on the capacitive touch display apparatus.

15. The capacitive touch display apparatus of claim 14, wherein the digital signal processing module calculates a difference between the digital signal and a standard signal, and calculates the touch position of the touch object on the capacitive touch display apparatus based on the difference using a barycenter algorithm.
